(19) United States
(12) Patent Application Publication
(10) Pub. No.: US 2024/0103174 A1
(43) Pub. Date: Mar. 28, 2024

(54) POINT CLOUD DATA COMPRESSION VIA BELOW HORIZON REGION DEFINITION

(71) Applicant: Innovusion, Inc., Sunnyvale, CA (US)

(72) Inventor: Chen Gu, San Jose, CA (US)

(73) Assignee: Innovusion, Inc., Sunnyvale, CA (US)

(21) Appl. No.: 18/239,591

(22) Filed: Aug. 29, 2023

Related U.S. Application Data
(60) Provisional application No. 63/409,663, filed on Sep. 23, 2022.

(51) Int. Cl. G01S 17/894; G01S 7/481

(52) U.S. Cl. CPC G01S 17/894; G01S 7/4817

(57) ABSTRACT

A computer-implemented method for compressing point cloud data obtained by a LiDAR system is provided. The method comprises obtaining uncompressed point cloud data. Each of the uncompressed point cloud data is represented by 3-dimensional coordinates identifying positions within a field-of-view of the LiDAR system. At least one of the 3-dimensional coordinates is derived from a ToF measured by transmitting a light beam and receiving return light formed based on the transmitted light beam. The method further comprises identifying one or more sub-groups of the uncompressed point cloud data for compression. The method further comprises encoding the one or more sub-groups of the uncompressed point cloud data using differential coordinates to obtain first encoded point cloud data, and providing the first encoded point cloud data to a processor to construct at least a part of a three-dimensional perception of the FOV.

### CROSS-REFERENCE TO RELATED APPLICATIONS

This application claims priority to U.S. Provisional Patent Application Ser. No. 63/409,663, filed Sep. 23, 2022, entitled “POINT CLOUD DATA COMPRESSION VIA BELOW HORIZON REGION DEFINITION”, the content of which is hereby incorporated by reference in its entirety for all purposes.

### FIELD OF THE TECHNOLOGY

This disclosure relates generally to light ranging and detection (LiDAR) technologies and, more particularly, to compressing point cloud data obtained by a LiDAR system.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

As LiDAR systems' resolution increases and as vehicles need to use more LiDAR units per vehicle, the amount of point cloud data being generated and transferred by the LiDAR units increases significantly. As a result, point cloud output data from LiDAR units need further data compression to enable better data streaming with limited bandwidth. Embodiments provided in this disclosure are computer-implemented systems and methods for improving the compression of point cloud data obtained by a LiDAR system.

In one embodiment, a computer-implemented method for compressing point cloud data obtained by a LiDAR system is provided. The method comprises obtaining uncompressed point cloud data from the LiDAR system. Each of the uncompressed point cloud data is represented by 3-dimensional coordinates identifying positions within a FOV of the LiDAR system. At least one of the 3-dimensional coordinates is derived from a ToF measured by transmitting a light beam to the FOV and receiving return light formed based on the transmitted light beam. The method further comprises identifying one or more sub-groups of the uncompressed point cloud data for compression. Data points of the one or more sub-groups represent positions of one or more regions within the FOV. The method further comprises encoding the one or more sub-groups of the uncompressed point cloud data using differential coordinates to obtain first encoded point cloud data, and providing the first encoded point cloud data to a processor to construct at least a part of a three-dimensional perception of the FOV.

In one embodiment, a LiDAR system configured to perform point cloud data compression is provided. The LiDAR system comprises a transmitter configured to transmit one or more light beams, a scanner configured to scan the one or more light beams to a FOV, a receiver configured to receive return light formed based on the scanned one or more light beams; and one or more processors. The LiDAR system further comprises a data receiver configured to obtain uncompressed point cloud data from the LiDAR system. Each of the uncompressed point cloud data is represented by 3-dimensional coordinates identifying positions within a FOV of the LiDAR system. At least one of the 3-dimensional coordinates is derived from a ToF measured by transmitting the one or more light beams to the FOV and receiving the return light based on the transmitted light beams. The LiDAR system further comprises a pre-compression processor configured to identify one or more sub-groups of the uncompressed point cloud data for compression. Data points of the one or more sub-groups represent positions of one or more regions within the FOV. The LiDAR system further comprises an encoder configured to encode the one or more sub-groups of the uncompressed point cloud data using differential coordinates to obtain first encoded point cloud data, and a data transmitter configured to provide the first encoded point cloud data to the one or more processors to construct at least a part of a three-dimensional perception of the FOV.

In one embodiment, a vehicle comprising a LiDAR system configured to perform point cloud data compression is provided. The LiDAR system comprises a transmitter configured to transmit one or more light beams, a scanner configured to scan the one or more light beams to a FOV, a receiver configured to receive return light formed based on the scanned one or more light beams; and one or more processors. The LiDAR system further comprises a data receiver configured to obtain uncompressed point cloud data from the LiDAR system. Each of the uncompressed point cloud data is represented by 3-dimensional coordinates identifying positions within a FOV of the LiDAR system. At least one of the 3-dimensional coordinates is derived from a ToF measured by transmitting the one or more light beams to the FOV and receiving the return light based on the transmitted light beams. The LiDAR system further comprises a pre-compression processor configured to identify one or more sub-groups of the uncompressed point cloud data for compression. Data points of the one or more sub-groups represent positions of one or more regions within the FOV. The LiDAR system further comprises an encoder configured to encode the one or more sub-groups of the uncompressed point cloud data using differential coordinates to obtain first encoded point cloud data, and a data transmitter configured to provide the first encoded point cloud data to the one or more processors to construct at least a part of a three-dimensional perception of the FOV.

In one embodiment, a non-transitory computer readable medium comprising a memory storing instructions for compressing point cloud data obtained by a LiDAR system is provided. When executed by one or more processors of at least one computing device, the instructions cause the at least one computing device to perform a method to compress point cloud data. The method comprises obtaining uncompressed point cloud data from the LiDAR system. Each of the uncompressed point cloud data is represented by 3-dimensional coordinates identifying positions within a FOV of the LiDAR system. At least one of the 3-dimensional coordinates is derived from a ToF measured by transmitting a light beam to the FOV and receiving return light formed based on the transmitted light beam. The method further comprises identifying one or more sub-groups of the uncompressed point cloud data for compression. Data points of the one or more sub-groups represent positions of one or more regions within the FOV. The method further comprises encoding the one or more sub-groups of the uncompressed point cloud data using differential coordinates to obtain first encoded point cloud data, and providing the first encoded point cloud data to a processor to construct at least a part of a three-dimensional perception of the FOV.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7 is a block diagram illustrating an example computer-implemented system for compressing point cloud data according to an embodiment.

FIGS. 8A-8D are diagrams illustrating examples of point cloud data represented by 3-dimensional coordinates according to some embodiments.

FIGS. 9A-9D are diagrams illustrating an example of encoding uncompressed point cloud data according to some embodiments.

FIG. 10A is a diagram illustrating an example of identifying sub-groups of the uncompressed point cloud data for compression according to an embodiment.

FIG. 10B is a diagram illustrating an example perception of a FOV constructed using LiDAR point cloud data according to an embodiment.

FIG. 11A is a diagram illustrating another example of identifying sub-groups of the uncompressed point cloud data for compression according to an embodiment.

FIG. 11B is a diagram illustrating another example perception of a FOV constructed using LiDAR point cloud data according to an embodiment.

FIG. 12 shows an illustrative method for compressing point cloud data according to some embodiments.

FIG. 13 shows an illustrative process for identifying sub-groups of uncompressed point cloud data for compression point cloud data according to some embodiments.

FIG. 14 shows an illustrative process for including data points of scanlines into sub-groups for compression point cloud data according to some embodiments.

FIG. 15 shows another illustrative process for including data points of scanlines into sub-groups for compressing point cloud data according to some embodiments.

FIG. 16 shows an illustrative process for encoding sub-groups of uncompressed point cloud data according to some embodiments.

FIG. 17 shows another illustrative method for compressing point cloud data obtained by a LiDAR system according to some embodiments.

FIG. 18 shows another illustrative method for compressing point cloud data obtained by a LiDAR system according to some embodiments.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first scanline could be termed a second scanline and, similarly, a second scanline could be termed a first scanline, without departing from the scope of the various described examples. The first scanline and the second scanline can both be scanlines and, in some cases, can be separate and different scanlines. In another example, a first pixel horizon could be termed a second pixel horizon and, similarly, a second pixel horizon could be termed a first pixel horizon, without departing from the scope of the various described examples. The first pixel horizon and the second pixel horizon can both be pixel horizons and, in some cases, can be separate and different pixel horizons. In another example, a first encoded point cloud data could be termed a second encoded point cloud data and, similarly, a second encoded point cloud data could be termed a first encoded point cloud data, without departing from the scope of the various described examples. The first encoded point cloud data and the second encoded point cloud data can both be encoded point cloud data and, in some cases, can be separate and different encoded point cloud data. In another example, a first header could be termed a second header and, similarly, a second header could be termed a first header, without departing from the scope of the various described examples. The first header and the second header can both be headers and, in some cases, can be separate and different headers.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

LiDAR systems use light beams to create point cloud of an external environment. In a LiDAR system, a transmitter transmits one or more light beams to a FOV. When the transmitted one or more light beams are scattered or reflected by an object in the FOV, a portion of the scattered or reflected light returns to the LiDAR system to form return light. A receiver receives the return light. As a result, point cloud data are generated based on ToF measurements by transmitting the one or more light beams to the FOV and receiving the return light based on the transmitted light beams. In a scanning-based LiDAR system, the LiDAR system comprises a scanner configured to direct the one or more light beams along one or more directions (e.g., horizontal and vertical scanlines) to facilitate the LiDAR system to map the external environment. Therefore, the generated LiDAR point cloud data has information related to the horizontal and vertical scanlines. For example, a typical LiDAR point cloud data format has four types of information, i.e., three types of coordinates in a 3-dimensional coordinate system and reflectivity/intensity. In one embodiment, the 3-dimensional coordinates comprise Cartesian coordinates in X, Y, and Z directions. The information related to horizontal and vertical scanlines is represented as many X and Y coordinates in the LiDAR point cloud data format. In one embodiment, the 3-dimensional coordinates comprise spherical coordinates (represented by horizontal angular coordinates θ, vertical angular coordinates φ, and distance coordinates r). The information related to horizontal and vertical scanlines is represented as many horizontal angular coordinates and vertical angular coordinates in the LiDAR point cloud data format. In some embodiments, the 3-dimensional coordinates comprise polar coordinates, or cylindrical coordinates; and the information related to horizontal and vertical scanlines can be represented accordingly.

A density of a point cloud refers to the number of measurements (data points) per area performed by the LiDAR system. The point cloud density relates to a LiDAR (light ranging and detection) resolution. Typically, a higher LiDAR resolution requires a larger point cloud density. As a result, a higher LiDAR resolution can lead to a larger number of data points along the one or more directions (e.g., horizontal and vertical scanlines), thereby a larger number of data points in the FOV (e.g., XY-coordinate plane in the 3-dimensional coordinates). Therefore, when a LiDAR resolution is high (e.g., 2 million points), a large number of bits (e.g., 100 million bits) are required to encode the 3-dimensional coordinates information in the LiDAR data format. For example, 16 bits may be required to encode a horizontal angular coordinate, 15 bits may be required to encode a vertical angular coordinate, and 11 bits may be required to encode a distance. In other words, total of 42 bits may be required to encode the 3-dimensional coordinates information for each data point in a point cloud. As LiDAR resolution further increases and as vehicles need to use more LiDAR units per vehicle, point cloud output data from LiDAR units can take up a large data space (e.g., 100-200 million bits). As a result, this may slow down speeds of data processing and communications between wired or wireless communication paths in the LiDAR units, or to external devices. Therefore, there is a need for compressing point cloud data to enable better data streaming with limited bandwidth. Further, to achieve a more efficient point cloud data compression in the LiDAR system, a method to identify regions with dense clusters of points for compression is desired.

Existing methods for point cloud data compression are not suitable for compressing point cloud data in the LiDAR system. There is no such a method focusing on identifying regions with dense clusters of points for compression. In contrast, existing 3-dimensional point cloud data formats have too many other types of information, such as object identification data, detection algorithm for specific objects or boundaries of the specific objects encoded into the data stream. It would not be efficient or even impracticable to convert these types of information to a LiDAR format. Therefore, there is also a need to establish a specialized LiDAR format for data compression.

Embodiments of present invention are described below. In various embodiments of the present invention, a computer-implemented method for compressing point cloud data specialized for a LiDAR system is provided. The method comprises obtaining uncompressed point cloud data. Each of the uncompressed point cloud data is represented by 3-dimensional coordinates identifying positions within a FOV of the LiDAR system. At least one of the 3-dimensional coordinates is derived from a ToF measured by transmitting a light beam to the FOV and receiving return light formed based on the transmitted light beam. The method further comprises identifying one or more sub-groups of the uncompressed point cloud data for compression. Data points of the one or more sub-groups represent positions of one or more regions within the FOV. The method further comprises encoding the one or more sub-groups of the uncompressed point cloud data using differential coordinates. As a result, first encoded point cloud data are obtained. The method further comprises providing the first encoded point cloud data to a processor to construct at least a part of a three-dimensional perception of the FOV.

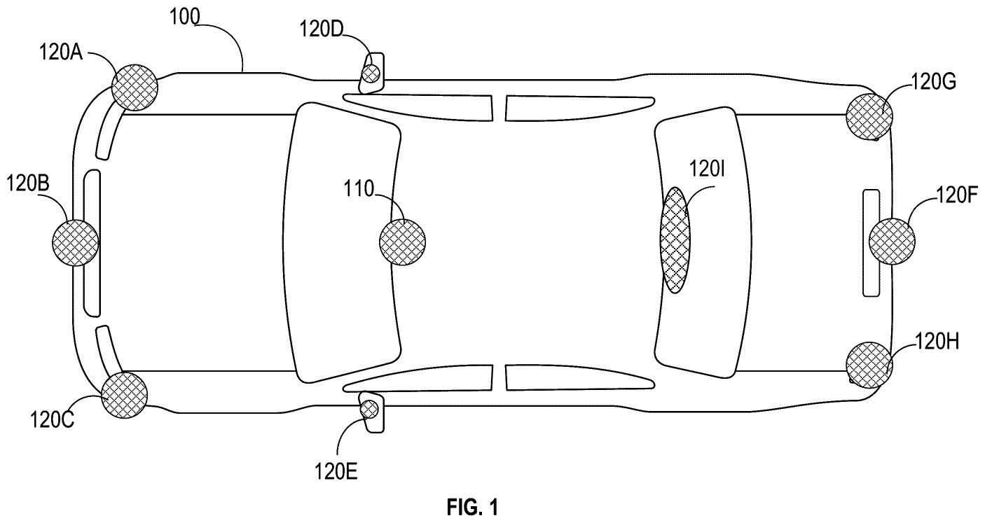

FIG. 1 illustrates one or more example LiDAR systems 110 disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, a unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but have no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

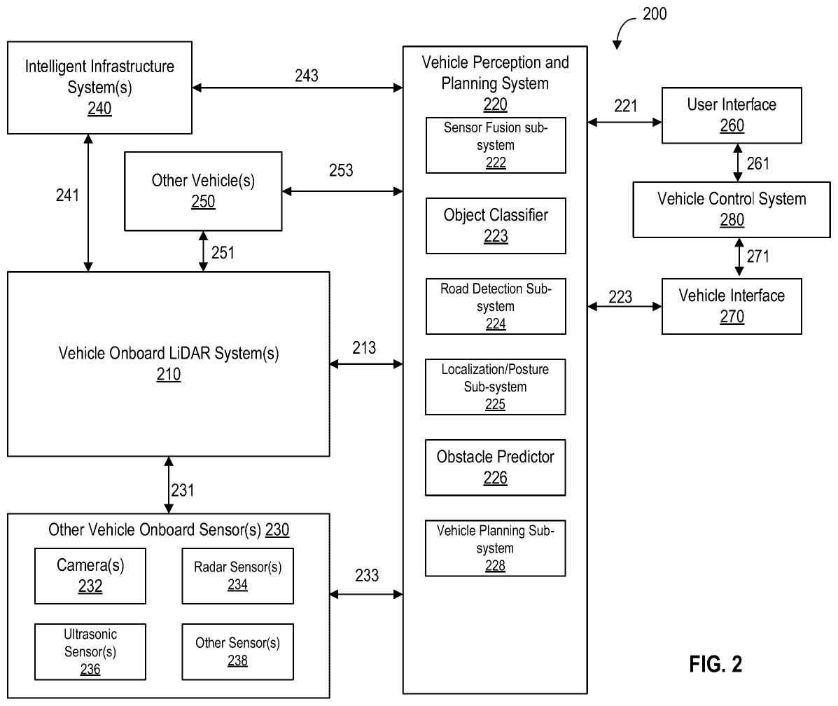

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitates producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mount on, or integrated to, a vehicle at any locations (e.g., rear-view mirrors, pillars, front grille, and/or back bumpers, etc.).

Other vehicle onboard sensor(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mount on, or integrated to, a vehicle at any locations (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any locations (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

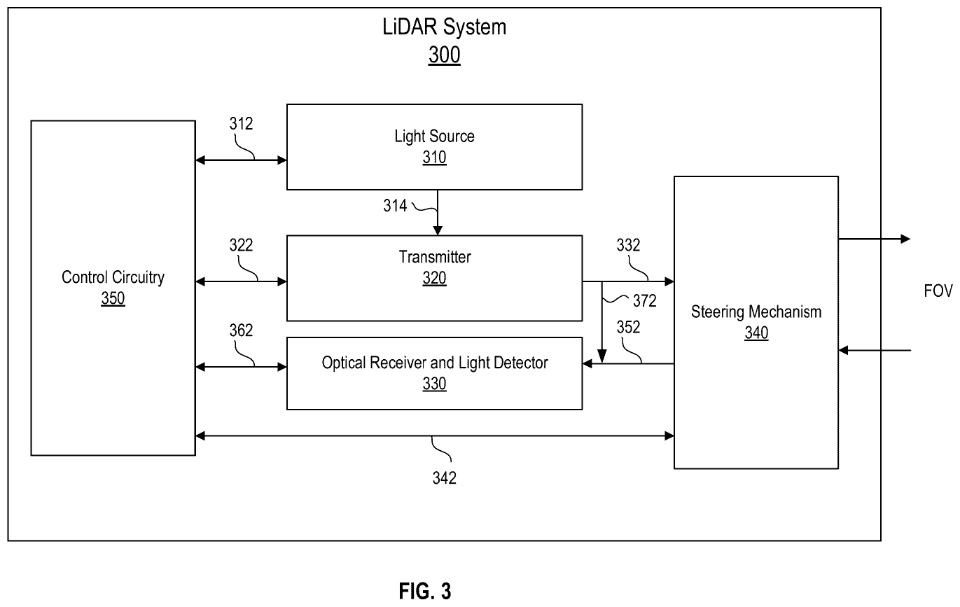

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

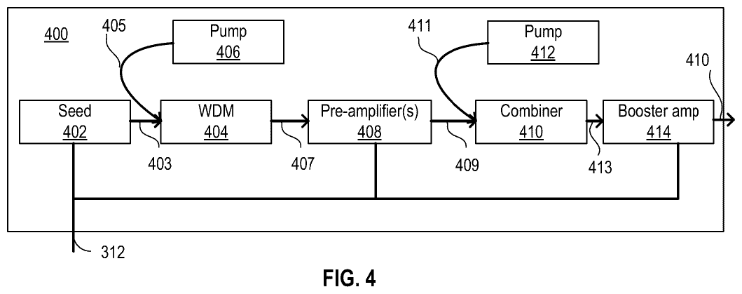

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 410. The booster amplifier 414 provides further amplification of the optical signals (e.g., another 20-40 dB). The outputted light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and /or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

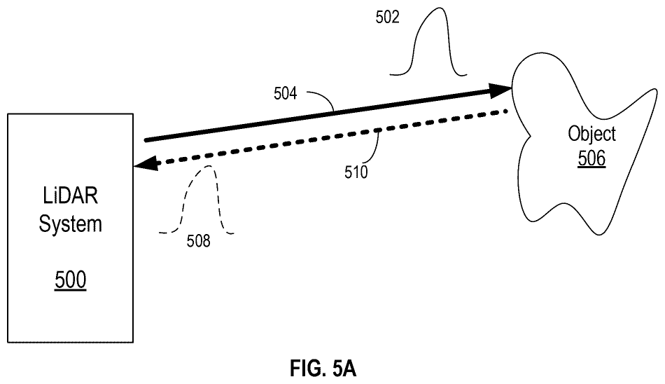

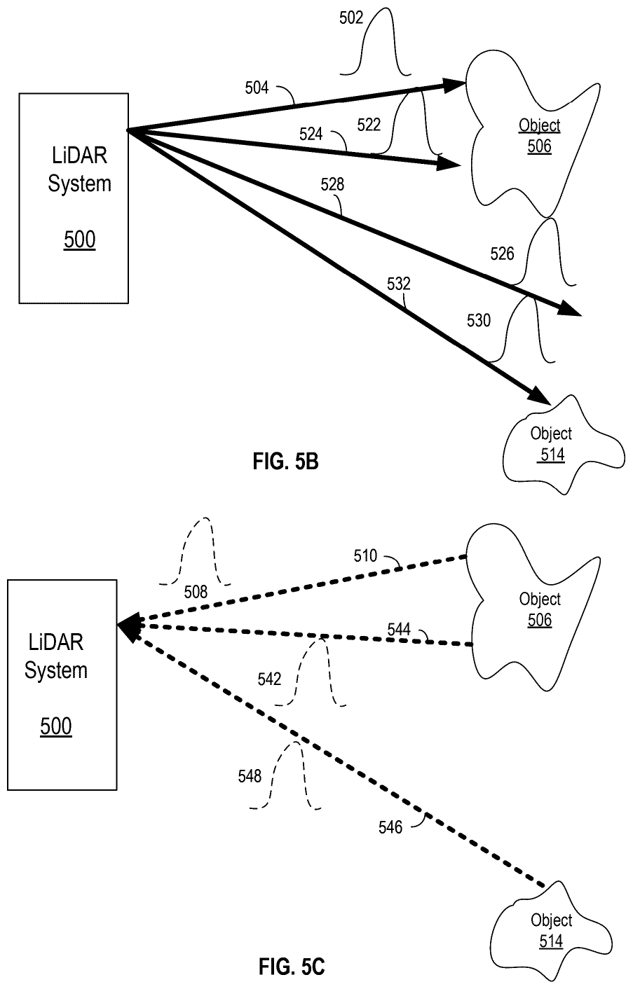

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHZ (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

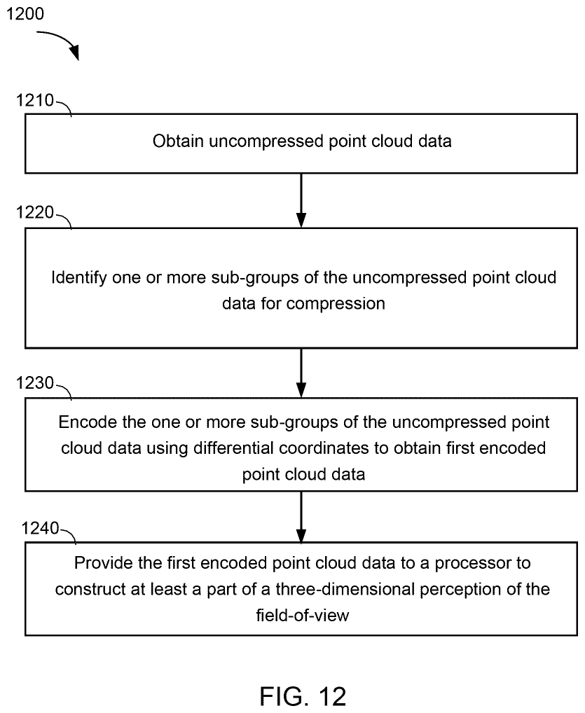

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 12-18, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

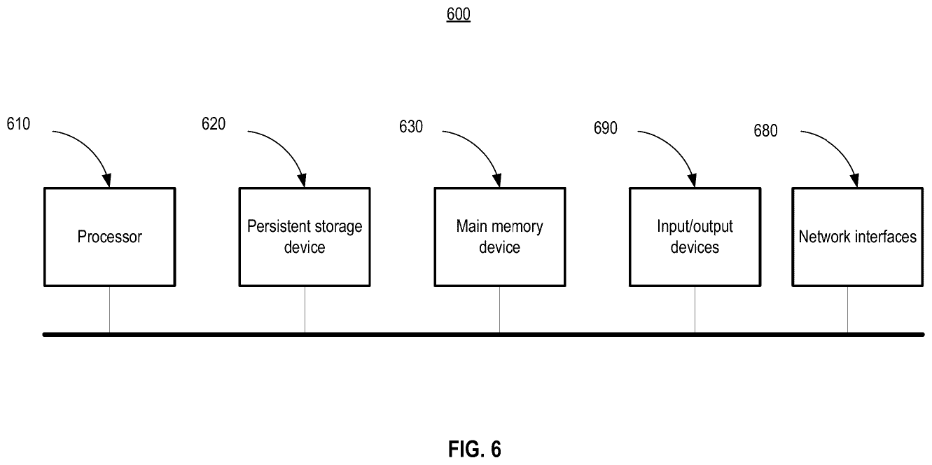

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 12-18 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 12-18. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

LiDAR systems use light beams to create a point cloud of an external environment. Point cloud data are generated based on ToF measurements by transmitting one or more light beams to a FOV and receiving return light based on the transmitted light beams. In a scanning-based LiDAR system, the LiDAR system comprises a scanner (e.g., steering mechanism 340 shown in FIG. 3) configured to direct the one or more light beams along one or more directions (e.g., horizontal and vertical scanlines) to facilitate the LiDAR system to map the external environment. Therefore, the generated LiDAR point cloud data has information related to the one or more scanlines. For example, a typical LiDAR point cloud data format has four types of information, i.e., three types of coordinates in a 3-dimensional coordinate system and reflectivity/intensity. In one embodiment, the 3-dimensional coordinates comprise Cartesian coordinates in X, Y, and Z directions. The information related to horizontal and vertical scanlines is represented as many X and Y coordinates in the LiDAR point cloud data format. In one embodiment, the 3-dimensional coordinates comprise spherical coordinates (represented by horizontal angular coordinates θ, vertical angular coordinates φ, and distance coordinates r). The information related to horizontal and vertical scanlines is represented as many horizontal angular coordinates and vertical angular coordinates in the LiDAR point cloud data format. In some embodiments, the 3-dimensional coordinates comprise polar coordinates, or cylindrical coordinates; and information related to the scanlines can be represented accordingly.

A density of a point cloud refers to the number of measurements (data points) per area performed by the LiDAR system. The point cloud density relates to a LiDAR resolution. Typically, a higher LiDAR resolution requires a larger point cloud density. As a result, a higher LiDAR resolution can lead to a larger number of data points along the one or more directions (e.g., horizontal and vertical scanlines), thereby a larger number of data points in the FOV (e.g., XY-coordinate plane in the 3-dimensional coordinates). Therefore, when a LiDAR resolution is high (e.g., 2 million points), a large number of bits (e.g., 100 million bits) are required to encode the 3-dimensional coordinates information in the LiDAR data format. For example, 16 bits are required to encode a horizontal angular coordinate; 15 bits are required to encode a vertical angular coordinate; and 11 bits are required to encode a distance. This results in a total of 42 bits for encoding the 3-dimensional coordinates information of a data point. Therefore, as LiDAR resolution increases and as vehicles need to use more LiDAR units per vehicle, point cloud output data from LiDAR units need further data compression to enable better data streaming with limited bandwidth.

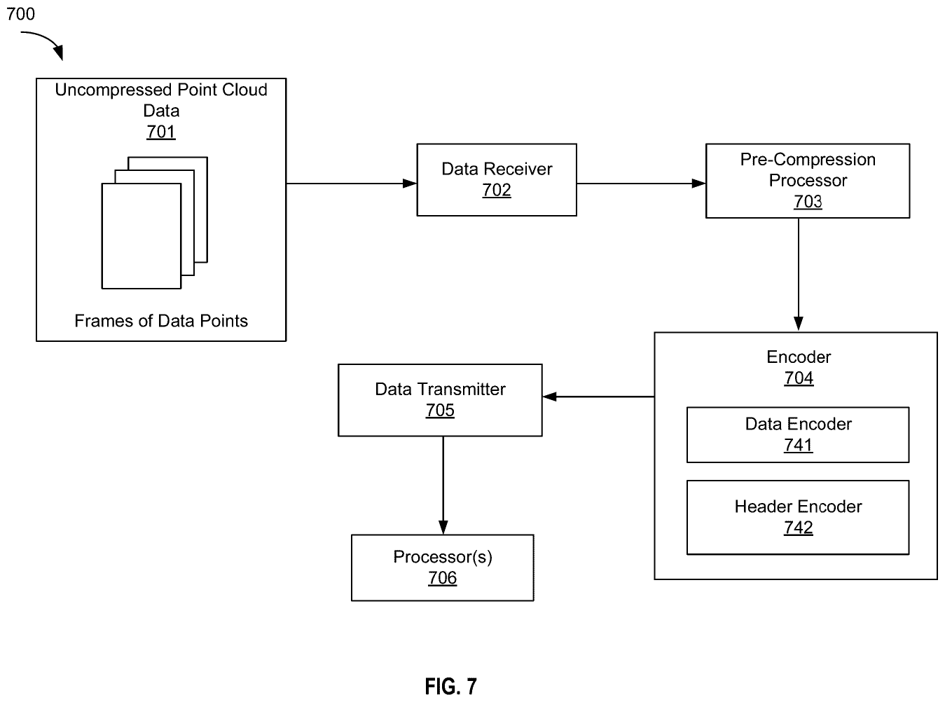

FIG. 7 illustrates an example computer-implemented system 700 for compressing point cloud data according to an embodiment. The system 700 is specialized for point cloud data compression for a LiDAR system (e.g., LiDAR system(s) 210, LiDAR system 300, or LiDAR system 500). For example, the system 700 can be used to implement one or more components and systems described herein, such as control circuitry 350 (shown in FIG. 3), vehicle perception and planning system 220 (shown in FIG. 2), and vehicle control system 280 (shown in FIG. 2).

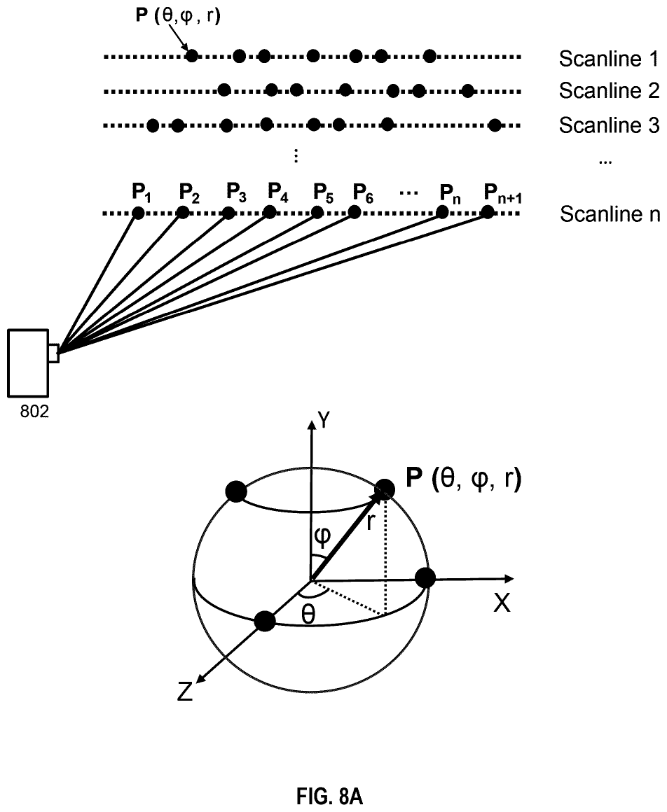

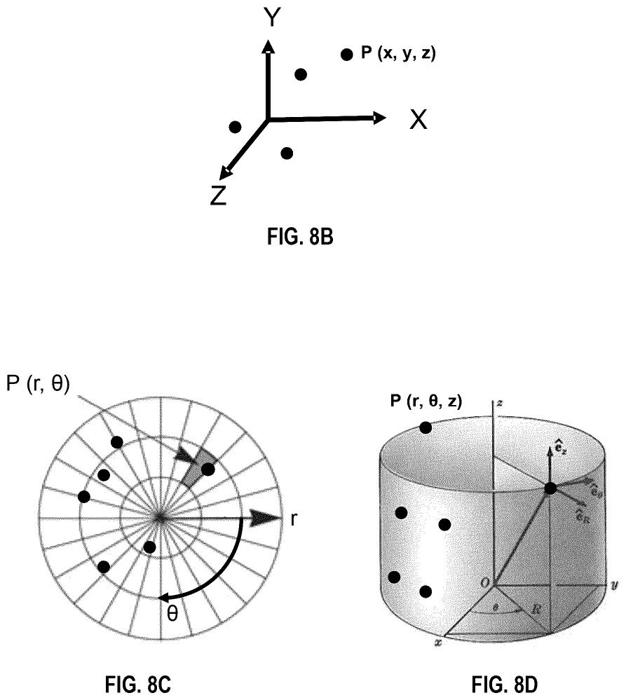

The LiDAR system generates uncompressed point cloud data 701. The system 700 comprises a data receiver 702 configured to obtain the uncompressed point cloud data 701. As shown in FIG. 7, the uncompressed point cloud data 701 comprise one or more frames of data points. Each of the uncompressed point cloud data 701 is represented by 3-dimensional coordinates identifying positions within a FOV of the LiDAR system. At least one of the 3-dimensional coordinates is derived from a ToF measured by transmitting the one or more light beams to the FOV and receiving the return light based on the transmitted light beams. This is described in detail further below with reference to FIGS. 8A-8D.

As shown in FIG. 7, the system 700 further comprises a data receiver 702, a pre-compression processor 703, an encoder 704, a data transmitter 705, and one or more processors 706. The encoder 704 includes a data encoder 741 configured to encode point cloud data, and a header encoder 742 configured to encode headers. The data receiver 702 obtains uncompressed point cloud data 701 from the LiDAR system. The pre-compression processor 703 identifies one or more sub-groups of the uncompressed point cloud data 701 for compression. Data points of the one or more sub-groups represent positions of one or more regions within the FOV.

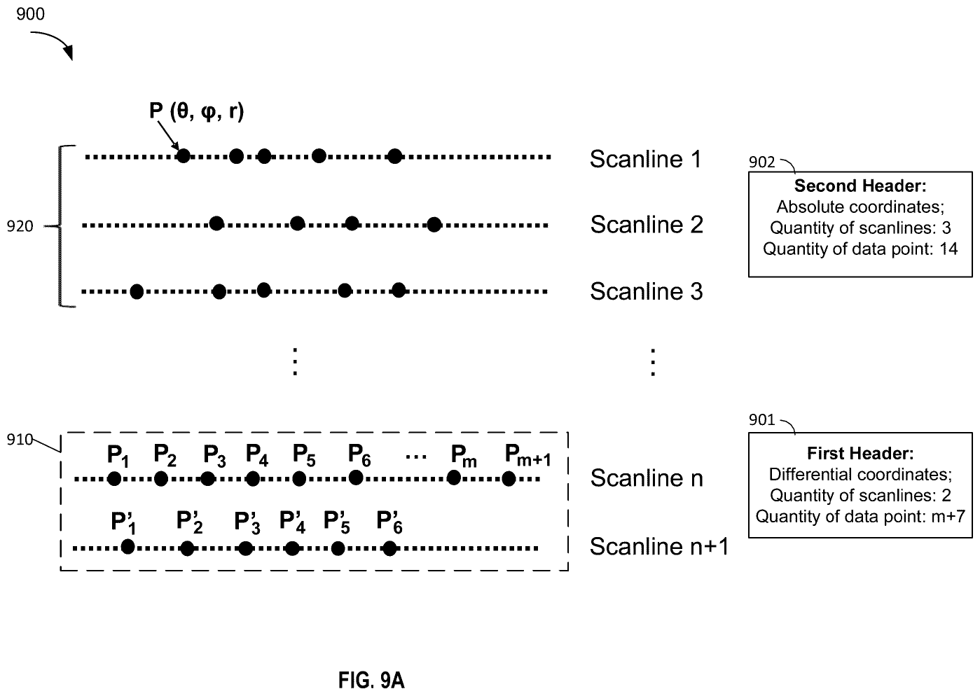

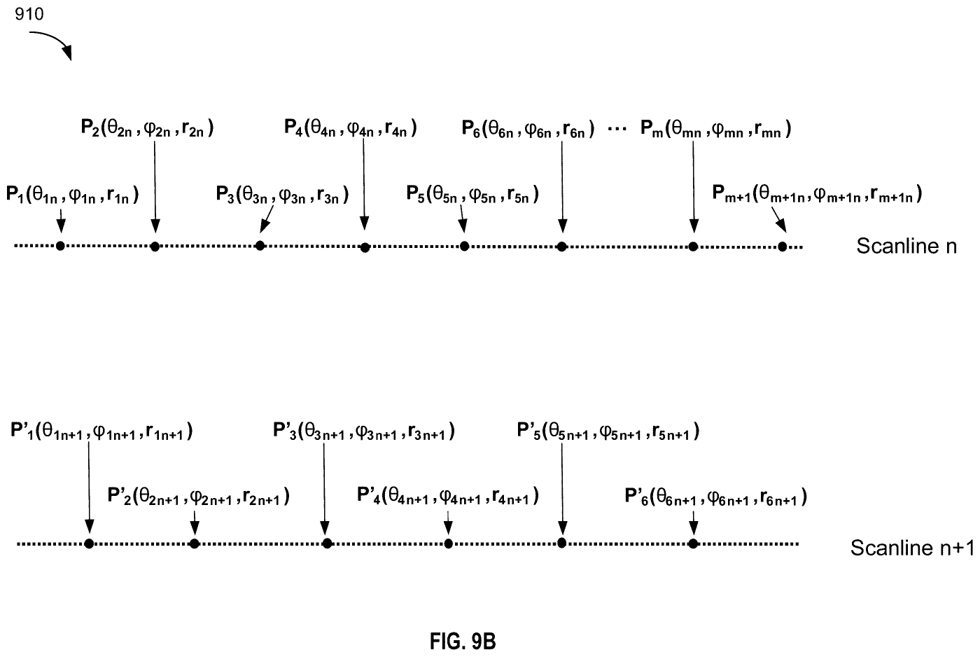

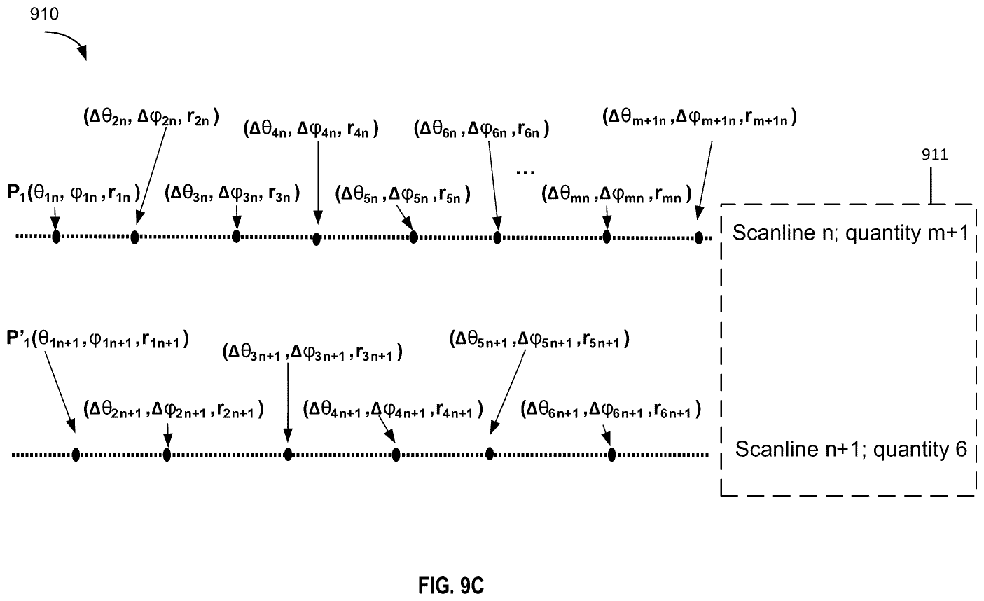

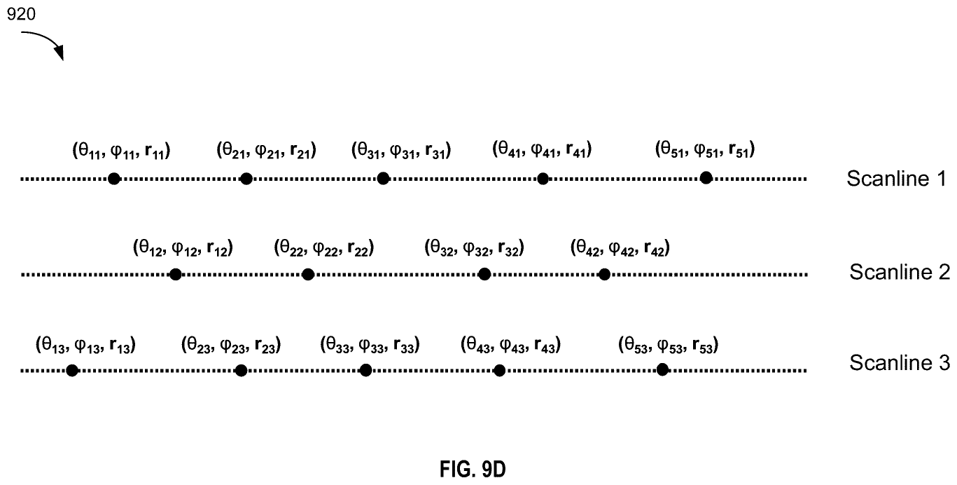

For each frame of the uncompressed point cloud data 701, the pre-compression processor 703 identifies one or more sub-groups for compression based on data point densities of a plurality of scanlines of the frame. For example, the pre-compression processor 703 computes the data point densities for each of the plurality of scanlines. Then the pre-compression processor 703 determines whether the data point density of the scanline is greater than or equal to a threshold data point density. In accordance with a determination that the data point densities of one or more scanlines are greater than or equal to the threshold data point density, the pre-compression processor 703 includes data points of at least the one or more scanlines into the one or more sub-groups for compression. This is described in detail further below with reference to FIGS. 9A-9D, 10A-10B and 11A-11B. In some embodiments, the data point density is a number of data points divided by a total number of laser firing cycles/transmission pulses in one scanline. This is a specialized LiDAR format data compression, because the LiDAR format of the uncompressed point cloud data 701 includes information related to the plurality of scanlines. Based on calculated data point densities of the plurality of scanlines, the pre-compression processor 703 can identify one or more sub-groups with dense clusters of points for compression, thereby achieving a more efficient data compression. This also facilitates more efficient and feasible data compression compared to other existing point cloud data compression, because objects encoded in existing point cloud data do not necessarily have information related to scanlines or data point densities of scanlines. Further, there is no need to convert other types of information, such as object identification data, e.g., identification algorithm for specific objects or boundaries of the specific objects, from the other existing point cloud data to the scanlines.

In some embodiments, after the one or more sub-groups for compression being identified, the data encoder 741 encodes the one or more sub-groups using differential coordinates. The differential coordinates represent differences between absolute coordinates of two neighboring data points of the uncompressed point cloud data. This is described in detail further below with reference to FIGS. 9A-9D. A quantity of bits required for encoding using the differential coordinates is less than a number of bits required for encoding using absolute coordinates of the 3-dimensional coordinates. As a result, the first encoded point cloud data with fewer number of bits can be obtained by encoder 704 and provided to data transmitter 705. The data transmitter 705 provides the first encoded point cloud data to one or more processors 706 to construct at least a part of a three-dimensional perception of the field-of-view.

In some embodiments, the header encoder 742 further encodes a first header. The first header can indicate that differential coordinates are used for obtaining the first encoded point cloud data. The first header can also indicate a quantity of scanlines or data points encoded in the first encoded point cloud data. In some embodiments, for data points other than the data points of the identified one or more sub-groups, the data encoder 741 encodes at least some data points other than the data points of the identified one or more sub-groups using absolute coordinates to obtain a second encoded point cloud data. Correspondingly, the header encoder 742 further encodes a second header. The second header indicates that absolute coordinates are used for obtaining the second encoded point cloud data. The second header also indicates a quantity of scanlines or data points encoded in the second encoded point cloud data. This is described in detail further below with reference to FIGS. 9A-9D.

FIG. 8A-D are diagrams illustrating examples of point cloud data represented by 3-dimensional coordinates. As shown in FIG. 8A, a LiDAR system 802 directs the one or more light beams along horizontal directions, and generates uncompressed point cloud data in a plurality of scanlines (e.g., Scanlines 1−n shown in FIG. 8A). The LiDAR system 802 can be implemented by any of the above-described LiDAR system (e.g., LiDAR system(s) 210, LiDAR system 300, or LiDAR system 500, etc.). A plurality of data points (e.g., data points P in FIG. 8) represented by 3-dimensional coordinates represent positions within a FOV of the LiDAR system.

As shown in FIG. 8A, the 3-dimensional coordinates comprise spherical coordinates represented by horizontal angular coordinates θ, vertical angular coordinates φ, and distance coordinates r. The distance coordinates r are also know as radical coordinates in a spherical coordinate system.

FIG. 8B-D are examples of point cloud data represented by 3-dimensional coordinates of Cartesian coordinates, polar coordinates, or cylindrical coordinates, respectively. For example, as shown in FIG. 8B, the 3-dimensional coordinates can be presented by a X coordinate, Y coordinate, and a Z coordinate in a Cartesian coordinate system. As shown in FIG. 8C, 2-dimensional coordinates of the 3-dimensional coordinates can be presented by a radical coordinate r and angular coordinates θ in a polar coordinate system. As shown in FIG. 8D, the 3-dimensional coordinates can be presented by a radical coordinates r, a horizontal angular coordinates θ, and a Z coordinate in a cylindrical coordinate system.

FIG. 9A is a diagram illustrating an example of encoding uncompressed point cloud data according to an embodiment. As shown in FIG. 9A, there are a plurality of data points (e.g., data points P shown in FIG. 9A) in each of scanlines (e.g., Scanline 1-Scanline n+1) in a frame of uncompressed point cloud data 900. Based on data point densities of the plurality of scanlines of the frame 900, a pre-compression processor (e.g., pre-compression processor 703 shown in FIG. 7) identifies one or more sub-groups for compression. This is a specialized LiDAR format data compression, because the plurality of scanlines exists in the frame of uncompressed point cloud data 900. Based on data point densities of the plurality of scanlines, the pre-compression processor can identify one or more sub-groups with dense clusters of points for compression, thereby achieving a more efficient data compression.

To achieve a more efficient point cloud data compression, a sub-group 910 with denser points is identified for compression as shown in FIG. 9A. For each of the plurality of scanlines (e.g., Scanline 1-Scanline n+1), the pre-compression processor computes the data point density of the scanline. The pre-compression processor determines whether the data point density of the scanline is greater than or equal to a threshold data point density. As shown in FIG. 9A, each two data points Pₘ and Pₘ₋₁ in a scanline are neighboring data points. In one embodiment, the determining can be a determination of whether an average distance between neighboring data points is less than a threshold data point distance. In one embodiment, the determining can be a determination of whether a quantity of the data points of the scanline is greater than or equal to a threshold data point quantity. For example, the threshold data point quantity is 6. As shown in FIG. 9A, a quantity of the data points the Scanline n is greater than the threshold data point quantity of 6 (e.g., m is an integer number greater than or equal to 7.). A quantity of the data points the Scanline n+1 is equal to the threshold data point quantity of 6. Therefore, the pre-compression processor determines data point densities of the Scanlines n and n+1 are greater than or equal to the threshold data point density. Therefore, the pre-compression processor includes data points of the scanlines n and n+1 (e.g., data points P₁-Pₘ₋₁ of the Scanline n and P₁′-P₆′ of the Scanline n+1) into a sub-group 901. A data encoder (e.g., data encoder 741 shown in FIG. 7) encodes the sub-group 910 using differential coordinates for compression to obtain a first encoded point cloud data. This is described in detail further below with reference to FIGS. 9B-9C. A data transmitter (e.g., data transmitter 705 shown in FIG. 7) provides the first encoded point cloud data to a processor to construct at least a part of a three-dimensional perception of the field-of-view.

A header encoder (e.g., header encoder 742 shown in FIG. 7) further encodes a first header 901 for the sub-group of the uncompressed point cloud data 901. As shown in FIG. 9A, the first header 901 indicates that differential coordinates are used for obtaining the first encoded point cloud data. In this example, the first header 901 also indicates that the quantity of scanlines encoded in the first encoded point cloud data is two. The first header 901 also indicates that a quantity of data points encoded in the first encoded point cloud data is m+7, where m is an integer number.

Some data points other than the data points of the identified sub-group 910 are included in a group 920. Group 920 may include data points that have a low point density (e.g., lower than the point density threshold) or may include no data points. As shown in FIG. 9A, data points in the Scanlines 1-3 are included in the group 920. The data encoder encodes the data points in 920 using absolute coordinates to obtain a second encoded point cloud data. This is described in detail further below with reference to FIG. 9D. The header encoder further encodes a second header 902. As shown in FIG. 9A, the second header 902 indicates that absolute coordinates are used for obtaining the second encoded point cloud data. In this example, the second header 902 also indicates that a quantity of scanlines encoded in the second encoded point cloud data is three. The second header 902 also indicates that a quantity of data points encoded in the second encoded point cloud data is 14.

FIG. 9B is a diagram illustrating an example of the sub-group 910 represented by 3-dimensional coordinates according to an embodiment. The plurality of data points P represented by 3-dimensional coordinates identifies positions within the FOV of the LiDAR system. As shown in FIG. 9B, the plurality of data points P is represented in a spherical coordinate system in horizontal angular coordinates θ, vertical angular coordinates φ, and a distance coordinates r. As for each coordinate, the first number in a subscript of the coordinate θ, φ, or r denotes an ordinal number for the data point in a scanline. The second number in the subscript denotes an ordinal number of the scanline. As mentioned above, the LiDAR system directs one or more light beams along a horizontal direction (e.g., a vertical angle φₙ) to generate the uncompressed point cloud data in a scanline (e.g., Scanline n). The data points P in a same scanline can have similar, but slightly changed vertical angular coordinates such that the scanline may not be an exactly straight line. For example, for Scanline n, vertical angular coordinates φ₁ₙ-φₘ₊₁ₙ for the data points P₁-Pₘ₊₁ may slightly vary around the vertical angle φₙ. For Scanline n+1, vertical angular coordinates φ₁ₙ₊₁-φ₆ₙ₊₁ for the data points P′₁-P′₆ can be similar to a vertical angle φₙ₊₁, but may not be exactly the same. Thus, when encoding or compressing the vertical angles φ, a delta between the data points can be encoded using differential coordinates.

FIG. 9C is a diagram illustrating an example of the sub-group 910 encoded using differential coordinates according to an embodiment. The differential coordinates represent differences between absolute coordinates of two neighboring data points (e.g., Pₘ and Pₘ₊₁) of the uncompressed point cloud data. Absolute coordinates are the 3-dimensional coordinates shown in FIG. 9B identifying the positions within the FOV. Using Scanline n as an example, the data point P₁ has its 3-dimensional coordinates of (θ₁ₙ, φ₁ₙ, r₁ₙ). The data point P₂ has its 3-dimensional coordinates of (θ₂ₙ, φ₂ₙ, r₂ₙ). The data point P₃ has its 3-dimensional coordinates of (θ₃ₙ, φ₃ₙ, r₃ₙ), and so forth. Here, the first number in a subscript of the coordinate θ, φ, or r denotes an ordinal number for the data point in the Scanline n. The second number n in the subscript denotes the Scanline n. For the encoding using differential coordinates, a data encoder (e.g., the data encoder 741) firstly encodes a first data point corresponding to the beginning of the scanline using absolute coordinates. As shown in FIG. 9C, the data point P₁ is encoded using its absolute coordinates of (θ₁ₙ, φₗₙ, rₗₙ). The data encoder further encodes subsequent data points of the scanline using differences of absolute coordinates between neighboring data points. As shown in FIG. 9C, continuing with the Scanline n as the example, difference between absolute coordinates of the two neighboring data points P₁ and P₂ is (Δθ₂ₙ, Δφ₂ₙ, r₂ₙ). The difference between absolute coordinates of two neighboring data points P₂ and P₃ is (Δθ₃ₙ, Δφ₃ₙ, r₂ₙ). Here, Δθ₂ₙ=θ₂ₙ−θ₁ₙ; Δθ₃ₙ=θ₃ₙ−θ₂ₙ, and so forth. Δφ₂ₙ=φ₂ₙ−φ₁ₙ; Δφ₃ₙ=φ₃ₙ−φ₂ₙ, and so forth. The distance coordinates r can change dramatically between neighboring data points in a scanline. Therefore, absolute distance coordinates r are still used for encoding the data points.

For using differential coordinates to encode data points of each scanline in the sub-group 910, the head encoder (e.g., encoder 742 shown in FIG. 7) further encodes a scanline header 911 for each of the scanlines. The scanline header 911 indicates a quantity of data points of the scanline. The scanline header 911 also indicates that a scanline is used for the encoding. As shown in FIG. 9C, the scanline header 911 for the Scanline n indicates that a quantity of data points is m+1 and the Scanline n is used for the encoding. The scanline header 911 for the Scanline n+1 indicates that a quantity of data points is 6 and the Scanline n+1 is used for the encoding.

As shown in FIG. 9C, horizontal angular coordinates θ and vertical angular coordinates φ are encoded Δθ and Δφ, respectively. The difference between absolute θ and φ coordinates of the two neighboring data points, which are much smaller than the corresponding θ and φ coordinates. Therefore, compared with a large number of bits required to encode the 3-dimensional absolute coordinates information in the LiDAR data format, using differential coordinates to encodes data points in scanlines can reduce the number of bits for encoding the 3-dimensional absolute coordinates of the data points. Therefore, a quantity of bits required for encoding using the differential coordinates is less than a number of bits required for encoding using the absolute coordinates. As a result, the point cloud data are compressed to enable better data streaming with limited bandwidth.

There is no change for the number of bits encoding distance coordinates, because absolute distance coordinates r are still used for encoding the data points. In some embodiments, a distance coordinate rₘₙ may equal to zero, if there is no point at horizontal angle θₘₙ and vertical angle φₘₙ. Here, m and n are integers numbers. The data point (θₘₙ, φₘₙ, rₘₙ) is referred to as an “empty point” or a “placeholder point”. This is to avoid having a large gap between neighboring data points in a scanline. Therefore, small values of Δθ and Δφ can be ensured when encoding the differential coordinates. Similarly, a reflectivity/intensity for the empty point is also equal to zero.

In some embodiments, for the encoding of the sub-group 910, the data encoder encodes coordinates of a beginning position and an end position of the sub-group. As shown in FIG. 9C, the data point P₁ is the beginning position. The coordinates of the beginning position P₁ are encoded using absolute coordinates of (θ₁ₙ, φ₁ₙ, r₁ₙ). The data point P′₆ is the ending position. The coordinates of the ending position P′₆ are encoded using differential coordinates of (Δθ₆ₙ₊₁, Δφ₆ₙ₊₁, r₆ₙ₊₁).

FIG. 9D is a diagram illustrating an example of the data points in the group 920 encoded using absolute coordinates according to an embodiment. As shown in FIG. 9D, data points in the Scanlines 1-3 are some data points other than the data points of the identified sub-group 910. Absolute coordinates are the 3-dimensional coordinates identifying the positions within the FOV. For example, as shown in FIG. 9D, the data points in the Scanline 1 are with 3-dimensional coordinates of (θ₁₁, φ₁₁, r₁₁), (θ₂₁, φ₂₁, r₂₁), (θ₃₁, φ₃₁, r₃₁), (θ₄₁, φ₄₁, r₄₁), and (θ₅₁, φ₅₁, r₅₁). Therefore, the data points in the Scanline 1 are encoded using absolute coordinates as (θ₁₁, φ₁₁, r₁₁), (θ₂₁, φ₂₁, r₂₁), (θ₃₁, φ₃₁, r₃₁), (θ₄₁, φ₄₁, r₄₁), and (θ₅₁, φ₅₁, r₅₁). The data encoder encodes at least some data points in the group 920 using the absolute coordinates to obtain a second encoded point cloud data. As described above, the number data points in group 920 may be lower than a threshold, and thus group 920 represents an area of fewer data points (compared to group 910). In some examples, these few data points may be farther away from one another. As a result, encoding data points in group 920 using differential coordinates may or may not be practical or efficient. Encoding can thus be performed using the absolute coordinates without impairing much of the data communication efficiency.

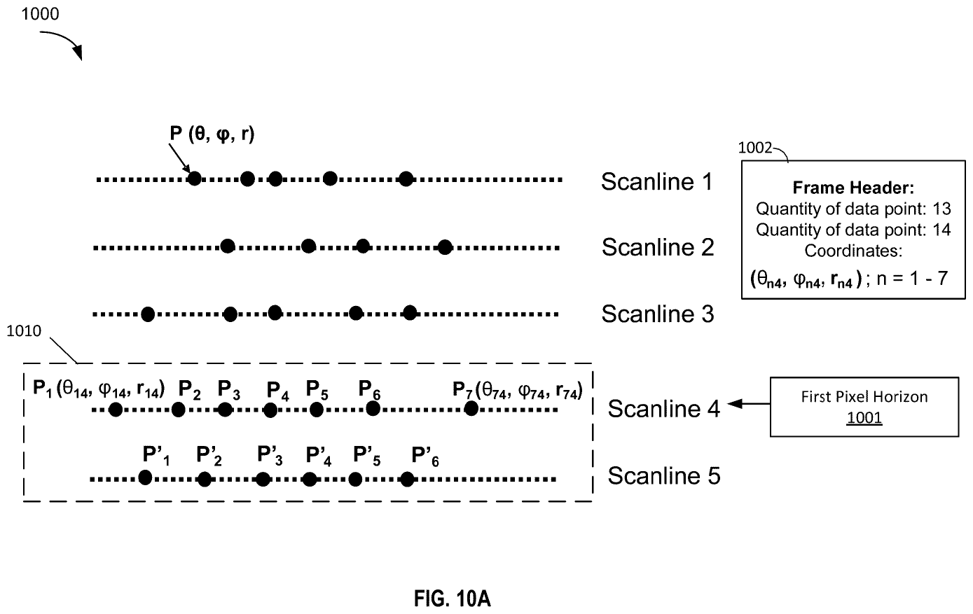

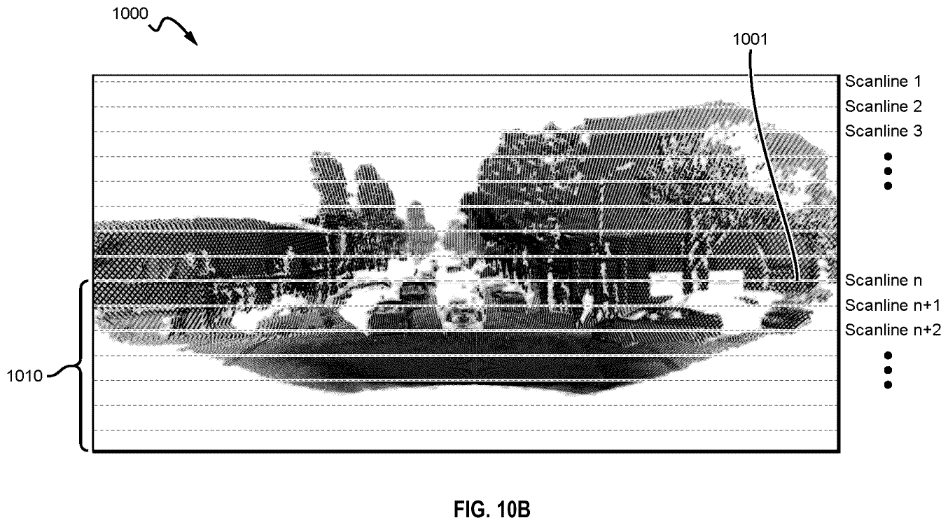

FIG. 10A is a diagram illustrating an example of identifying sub-groups of the uncompressed point cloud data for compression according to an embodiment. As shown in FIG. 10A, there are a plurality of data points P in each of scanlines (e.g., Scanlines 1-5). Based on data point densities of the plurality of scanlines, a pre-compression processor (e.g., pre-compression processor 703 shown in FIG. 7) identifies a sub-group of the uncompressed point cloud data 1010 for compression. For each of the Scanlines 1-5, the pre-compression processor computes the data point density of the scanline. In some embodiments, the data point density is the number of data points divided by total number of laser firing cycles/transmission pulses in one scanline. The pre-compression processor determines whether the data point density of the scanline is greater than or equal to a threshold data point density. In some embodiments, the determining can be a determination of whether an average distance between neighboring data points of the scanline is less than a threshold data point distance. In some embodiments, the determining can be a determination of whether a quantity of the data points of the scanline is greater than or equal to a threshold data point quantity. For example, the threshold data point quantity is 6. As shown in FIG. 10A, quantity of the data points of the Scanline 4 is greater than the threshold data point quantity of 6. Quantity of the data points of the Scanline 5 is equal to the threshold data point quantity of 6. Therefore, the pre-compression processor determines data point densities of the Scanlines 4 and 5 are greater than or equal to the threshold data point density. Therefore, the pre-compression processor identifies a sub-group of the uncompressed point cloud data 1010 for compression. The sub-group 1010 includes the data points of the scanlines 4 and 5.

In some embodiments, the pre-compression processor further selects a first scanline of the one or more scanlines in sub-group 1010 as a first pixel horizon 1001. As shown in FIG. 10A, the Scanline 4 is selected as the first pixel horizon 1001. Scanlines located above the first pixel horizon 1001 have data point densities less than the threshold data point density. Scanlines located at and below the first pixel horizon 1001 have data point densities greater than or equal to the threshold data point density. Therefore, the pre-compression processor includes data points of all scanlines (e.g., scanlines 4 and 5) positioned at and below the first pixel horizon 1001 in the first sub-group 1001.

A header encoder (e.g., header encoder 742 shown in FIG. 7) further encodes a frame header 1002. As shown in FIG. 10A, the frame header 1002 indicates a quantity of data points of the identified sub-group 1010 of the uncompressed point cloud data. In this example, the quantity of data points of the identified sub-group 1010 is 13. The frame header 1002 also indicates a quantity of data points other than the data points included in the identified sub-group 1010 of the uncompressed point cloud data. In this example, the quantity of data points other than the data points included in the identified sub-group 1010 is 14. The frame header 1002 also indicates one or more coordinates representing the Scanline 4 selected as the first pixel horizon 1001. As shown in FIG. 10A, the coordinates representing the Scanline 4 selected as the first pixel horizon 1001 are (θₙ₄, φₙ₄, rₙ₄); where n=1-7. Scanlines (e.g., Scanlines 1-3) located on one side of the first pixel horizon 1001 have data point densities that are less than a threshold data point density. Scanlines (e.g., Scanlines 4 and 5) located at and on the other side of the first pixel horizon 1001 have data point densities that are greater than or equal to the threshold data point density.

FIG. 10B is a diagram illustrating an example perception of a FOV constructed using LiDAR point cloud data according to an embodiment. The example shown in FIG. 10B illustrates the scenario in FIG. 10A. As shown in FIG. 10B, uncompressed point cloud data are presented by many data points in each of a plurality of scanlines. A pre-compression processor (e.g., pre-compression processor 703 shown in FIG. 7) identifies one or more sub-groups of the uncompressed point cloud data for compression based on data point densities of the scanlines. As described above, the pre-compression processor computes the data point density of the scanline and determines whether the data point density of the scanline is greater than or equal to a threshold data point density, based on a threshold data point quantity and/or a threshold data point distance.

To achieve a more efficient data compression, the pre-compression processor identifies regions with dense clusters of points for compression. As shown in FIG. 10B, the data points above the Scanline n are sparse number, because no or small amount of return light is received from objects in the sky, if any. In contrast, dense clusters of data points are obtained below the Scanline n, because more return light is received from the reflection of objects such as vehicles, buildings, trees, people, etc. Therefore, the pre-compression processor selects Scanline n as a first pixel horizon 1001. Scanlines located above the first pixel horizon 1001 have data point densities that are less than the threshold data point density. Scanlines located at and below the first pixel horizon 1001 have data point densities that are greater than or equal to the threshold data point density. Therefore, the pre-compression processor includes data points positioned at and below the first pixel horizon 1001 in a first sub-group 1010 for compression.

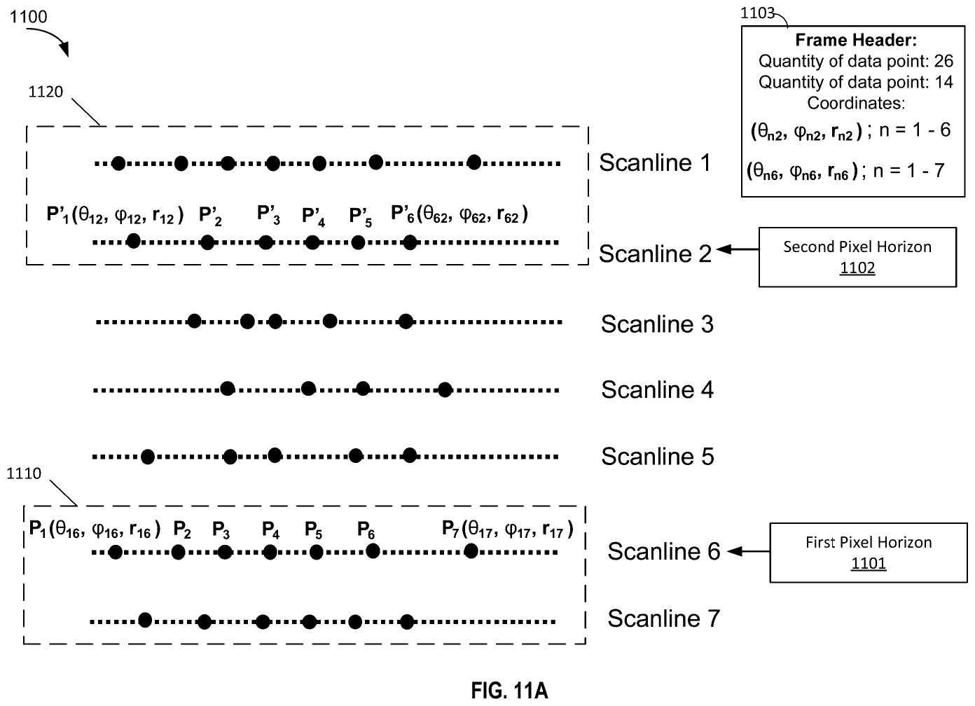

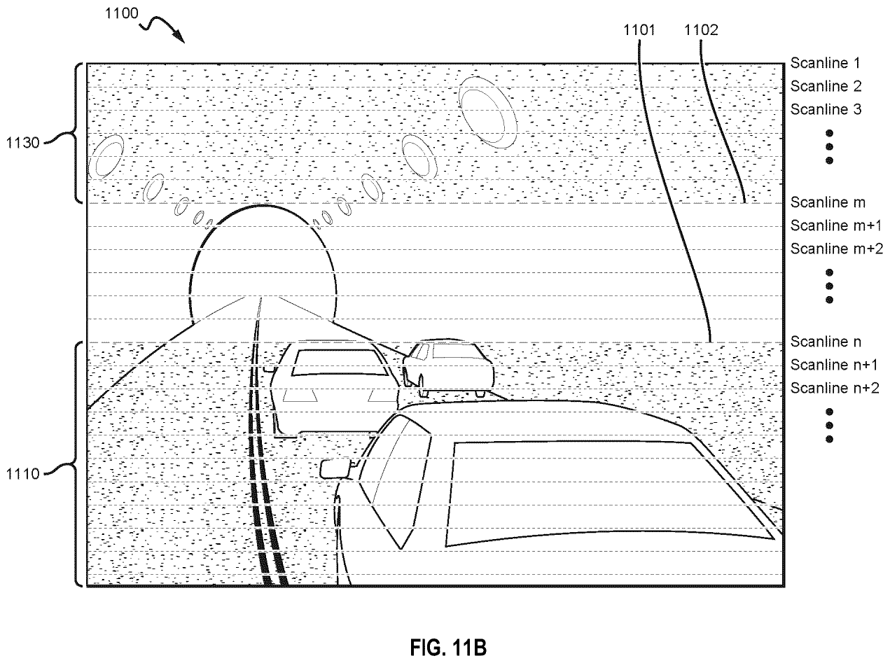

FIG. 11A is a diagram illustrating another example of identifying sub-groups of the uncompressed point cloud data for compression. As shown in FIG. 11A, there are a plurality of data points P in each of scanlines (e.g., Scanlines 1-7). Based on data point densities of the plurality of scanlines of the frame 1100, a pre-compression processor (e.g., pre-compression processor 703 shown in FIG. 7) identifies one or more sub-groups of the uncompressed point cloud data 1110 and 1120 for compression. The pre-compression processor computes the data point density for each of the Scanlines 1-7. The pre-compression processor determines whether the data point density of the scanline is greater than or equal to a threshold data point density. In some embodiments, the determining can be a determination of whether an average distance between neighboring data points of the scanline is less than a threshold data point distance. In some embodiments, the determining can be a determination of whether a quantity of the data points of the scanline is greater than or equal to a threshold data point quantity. For example, the threshold data point quantity is 6. As shown in FIG. 11A, quantities of the data points of the Scanlines 1, 2, 6, and 7 are greater than or equal to the threshold data point quantity of 6. Therefore, the pre-compression processor determines data point densities of the Scanlines 1, 2, 6, and 7 are greater than or equal to the threshold data point density. Therefore, the pre-compression processor identifies two sub-groups 1110 and 1120 for compression. The sub-group 1110 includes the data points of the Scanlines 6 and 7. The sub-group 1120 includes the data points of the Scanlines 1 and 2.

The pre-compression processor further selects a first scanline of the one or more scanlines as a first pixel horizon 1101. As shown in FIG. 11A, the Scanline 6 is selected as the first pixel horizon 1101. Scanlines located above the first pixel horizon 1101 have data point densities less than the threshold data point density. Scanlines located at and below the first pixel horizon 1101 have data point densities greater than or equal to the threshold data point density. Therefore, the pre-compression processor includes data points of all scanlines (e.g., Scanlines 6 and 7) positioned at and below the first pixel horizon 1101 in the first sub-group 1110.

The pre-compression processor further selects a second scanline of the one or more scanlines as a second pixel horizon 1102. As shown in FIG. 11A, the Scanline 2 is selected as the second pixel horizon 1102. Scanlines located at and above the second pixel horizon 1102 have data point densities greater than or equal to the threshold data point density. Scanlines located above the first pixel horizon 1101 and below the second pixel horizon 1102 have data point densities less than the threshold data point density. Therefore, the pre-compression processor includes data points of all scanlines (e.g., Scanlines 1 and 2) positioned at and above the second pixel horizon 1102 in a second sub-group 1120.

A header encoder (e.g., header encoder 742 shown in FIG. 7) further encodes a frame header 1103. As shown in FIG. 11A, the frame header 1103 indicates a quantity of data points of the identified sub-groups 1110 and 1120 of the uncompressed point cloud data. In this example, the quantity of data points of the identified sub-groups 1110 and 1120 is 26. The frame header 1103 also indicates a quantity of data points other than the data points included in the identified sub-groups 1110 and 1120 of the uncompressed point cloud data. The quantity of data points other than the data points included in the identified sub-groups 1110 and 1120 is 14. The frame header 1103 also indicates coordinates representing the Scanlines 6 and 2 selected as the first pixel horizon 1101 and the second pixel horizon 1102, respectively. As shown in FIG. 11A, the coordinates representing the Scanline 6 selected as the first pixel horizon 1101 are (θₙ₆, φₙ₆, rₙ₆); where n=1-7. Scanlines (e.g., Scanlines 3-5) located on one side of the first pixel horizon 1101 have data point densities that are less than a threshold data point density. Scanlines (e.g., Scanlines 6 and 7) located at and on the other side of the first pixel horizon 1101 have data point densities that are greater than or equal to the threshold data point density. The coordinates representing the Scanline 2 selected as the second pixel horizon 1102 are (θₙ₂, φₙ₂, rₙ₂); where n=1-6. Scanlines (e.g., Scanlines 3-5) located on one side of the second pixel horizon 1102 have data point densities that are less than a threshold data point density. Scanlines (e.g., Scanlines 1 and 2) located at and on the other side of the second pixel horizon 1102 have data point densities that are greater than or equal to the threshold data point density.

FIG. 11B is a diagram illustrating another example perception of a FOV constructed using LiDAR point cloud data according to an embodiment. The example shown in FIG. 11B illustrates the scenario of FIG. 11A. As shown in FIG. 11B, uncompressed point cloud data are presented by many data points in each of a plurality of scanlines. As described above, A pre-compression processor (e.g., pre-compression processor 703 shown in FIG. 7) identifies one or more sub-groups of the uncompressed point cloud data for compression based on data point densities of the scanlines. The pre-compression processor computes the data point density of the scanline and determines whether the data point density of the scanline is greater than or equal to a threshold data point density, based on a threshold data point quantity and/or a threshold data point distance.

To achieve a more efficient data compression, the pre-compression processor identifies regions with dense clusters of points for compression. As shown in FIG. 11B, data points may be sparse above the Scanline n and below the Scanline m, because less return light from objects in the sky, if any, is received. In contrast, in this scenario, dense points are below the Scanline n, or above the Scanline m, because more return light is received from tunnel walls and vehicles. Therefore, the pre-compression processor selects Scanline n as a first pixel horizon 1101 and Scanline m as a second pixel horizon 1102. Scanlines located at and below the first pixel horizon 1101 have data point densities that are greater than or equal to the threshold data point density. Scanlines located at and above the second pixel horizon 1102 have data point densities that are greater than or equal to the threshold data point density. Scanlines located between the first pixel horizon 1101 and the second pixel horizon 1102 have data point densities that are less than the threshold data point density. Therefore, the pre-compression processor includes data points positioned at and below the first pixel horizon 1001 in a first sub-group 1110 for compression. The pre-compression processor further includes data points positioned at and above the second pixel horizon 1102 in a second sub-group 1120 for compression.

FIG. 12 shows a flowchart illustrating an example computer-implemented method 1200 for compressing point cloud data according to some embodiments. The method 1200 of point cloud data compression is specialized for a LiDAR system.

The method 1200 is performed by a system (e.g., computer-implemented system 700) comprising a data receiver (e.g., data receiver 702 shown in FIG. 7), a pre-compression processor (e.g., pre-compression processor 703 shown in FIG. 7), a data encoder (e.g., data encoder 741 shown in FIG. 7), a header encoder (e.g., data encoder 742 shown in FIG. 7), a data transmitter (e.g., data transmitter 705 shown in FIG. 7), and one or more processors (e.g., processor(s) 706 shown in FIG. 7).

In step 1210 of method 1200, the data receiver obtains uncompressed point cloud data. The uncompressed point cloud data are generated by the LiDAR system. Each of the uncompressed point cloud data is represented by 3-dimensional coordinates identifying positions within a FOV of the LiDAR system. At least one of the 3-dimensional coordinates is derived from a ToF measured by transmitting the one or more light beams to the FOV and receiving the return light based on the transmitted light beams. In one embodiment, the 3-dimensional coordinates comprise Cartesian coordinates in X, Y, and Z directions. In one embodiment, the 3-dimensional coordinates comprise spherical coordinates represented by horizontal angular coordinates, vertical angular coordinates, and distance coordinates. In some embodiments, the 3-dimensional coordinates comprise polar coordinates, or cylindrical coordinates.

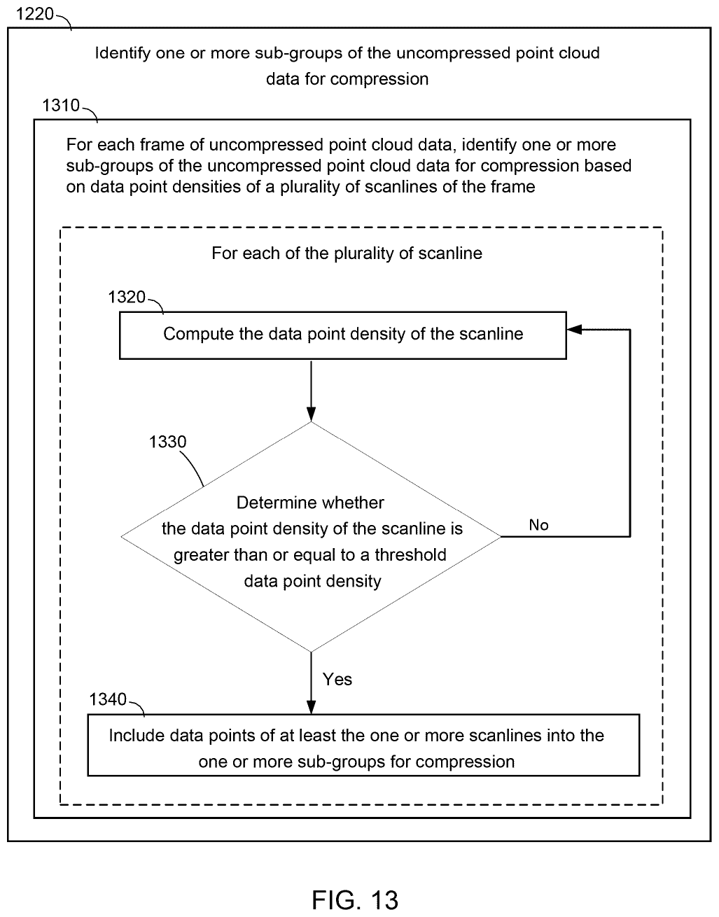

In step 1220 of method 1200, the pre-compression processor identifies one or more sub-groups of the uncompressed point cloud data for compression. Data points of the one or more sub-groups represent positions of one or more regions within the FOV. This is described in detail further below with reference to FIGS. 13-15.

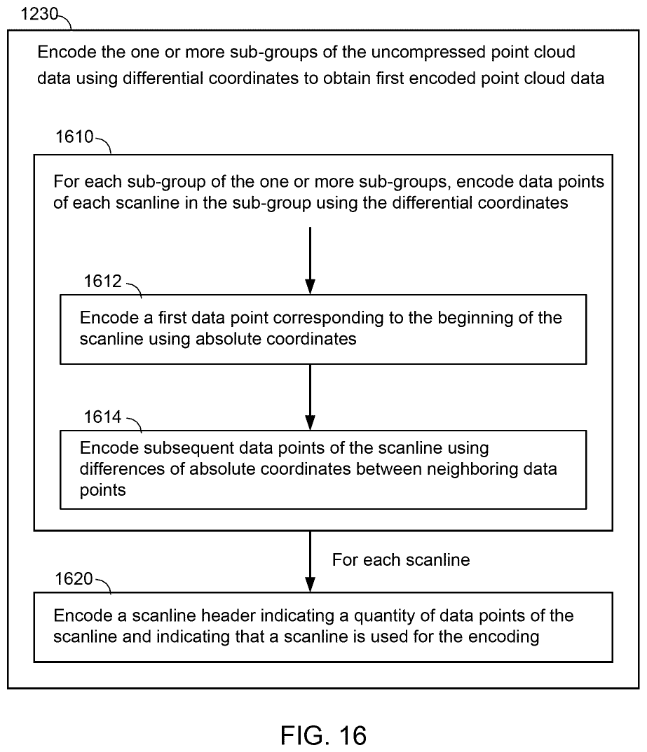

In step 1230 of method 1200, the data encoder encodes the one or more sub-groups of the uncompressed point cloud data using differential coordinates to obtain first encoded point cloud data. In some embodiments, the data encoder encodes coordinates of a beginning position and an end position of the sub-groups. This is described in detail further below with reference to FIG. 16. The differential coordinates represent differences between absolutes coordinates of two neighboring data points of the uncompressed point cloud data. A quantity of bits required for encoding using the differential coordinates is less than a number of bits required for encoding using absolute coordinates.

In step 1240 of method 1200, the data transmitter provides the first encoded point cloud data to the one or more processors to construct at least a part of a three-dimensional perception of the FOV.

FIG. 13 shows a flowchart illustrating an example method 1220 for identifying sub-groups of uncompressed point cloud data according to some embodiments. The step 1220 in FIG. 13 is the same step 1220 in FIG. 12. The pre-compression processor identifies one or more sub-groups of the uncompressed point cloud data for compression. The uncompressed point cloud data comprise one or more frames of data points.

In step 1310 in FIG. 13, for each frame of the uncompressed point cloud data, the pre-compression processor identifies the one or more sub-groups for compression based on data point densities of a plurality of scanlines of the frame.

In step 1320 in FIG. 13, for each of the plurality of scanlines, the pre-compression processor computes the data point density of the scanline.

In step 1330 in FIG. 13, for each of the plurality of scanlines, the pre-compression processor further determines whether the data point density of the scanline is greater than or equal to a threshold data point density. In some embodiments, the pre-compression processor determines whether an average distance between neighboring data points of the scanline is less than a threshold data point distance. In some embodiments, the pre-compression processor determines whether a quantity of the data points of the scanline is greater than or equal to a threshold data point quantity.

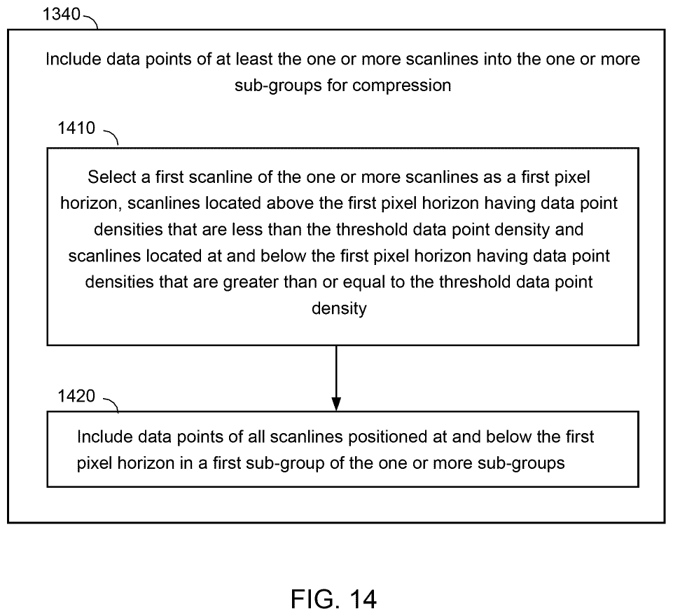

In step 1340 in FIG. 13, in accordance with a determination that the data point densities of one or more scanlines are greater than or equal to the threshold data point density, the pre-compression processor includes data points of at least the one or more scanlines into the one or more sub-groups for compression. This is described in detail further below with reference to FIG. 14.

FIG. 14 shows a flowchart illustrating an example method 1340 for including data points of scanlines into sub-groups for compression according to some embodiments. The step 1340 in FIG. 14 is the same step 1340 in FIG. 13. The pre-compression processor includes data points of at least the one or more scanlines into the one or more sub-groups for compression.

In step 1410 in FIG. 14, the pre-compression processor selects a first scanline of the one or more scanlines as a first pixel horizon. Scanlines located above the first pixel horizon have data point densities less than the threshold data point density. Scanlines located at and below the first pixel horizon have data point densities greater than or equal to the threshold data point density. Therefore, there is sparse amount of points regions above the first pixel horizon. In contrast, regions with dense clusters of points are below the first pixel horizon.

In step 1420 in FIG. 14, the pre-compression processor includes data points of all scanlines positioned at and below the first pixel horizon in a first sub-group of the one or more sub-groups. As a result, the pre-compression processor identifies regions with dense clusters of points for the compression, i.e., data points at and below the first pixel horizon, thereby achieving a more efficient data compression.

In some embodiments, the header encoder further encodes a frame header. The frame header indicates a quantity of data points of the identified one or more sub-groups of the uncompressed point cloud data. The frame header also indicates a quantity of data points other than the data points included in the identified one or more sub-groups of the uncompressed point cloud data. The frame header also indicates one or more coordinates representing one or more scanlines selected as pixel horizons. For each pixel horizon, scanlines located on one side of the pixel horizon have data point densities that are less than a threshold data point density. Scanlines located at and on the other side of the pixel horizon have data point densities that are greater than or equal to the threshold data point density.

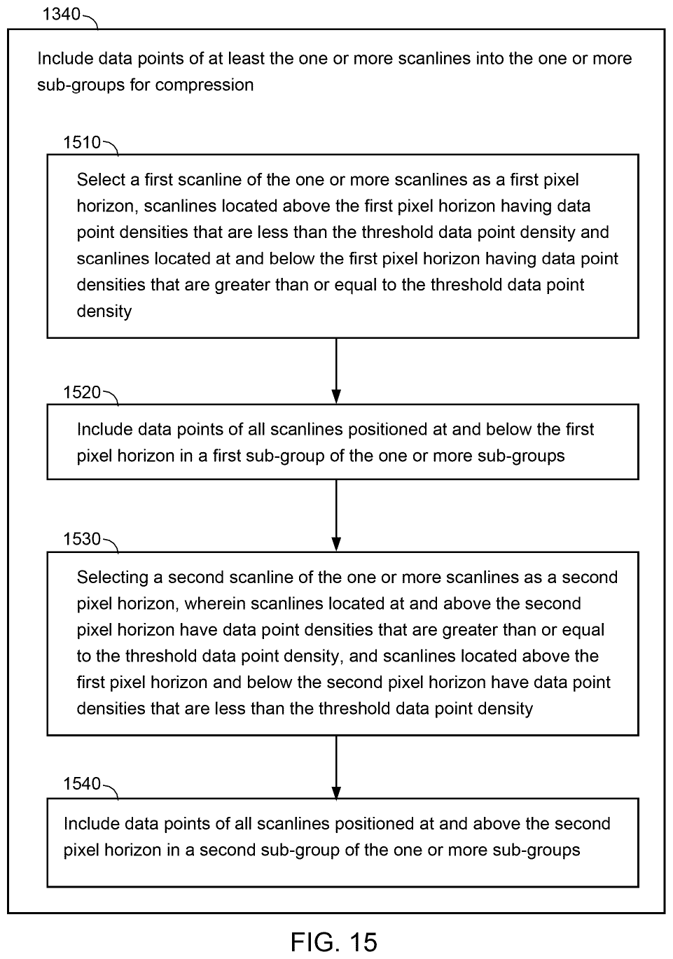

FIG. 15 is a flowchart illustrating another example method 1340 for including data points of scanlines into sub-groups for compression. The step 1440 in FIG. 15 is the same step 1340 in FIGS. 13 and 14. The pre-compression processor includes data points of at least the one or more scanlines into the one or more sub-groups for compression.

The steps 1510 in FIG. 15 is the same step 1410 in FIG. 14. The pre-compression processor includes data points of all scanlines positioned at and below the first pixel horizon in a first sub-group of the one or more sub-groups.

The steps 1520 in FIG. 15 is the same step 1420 in FIG. 14. the pre-compression processor includes data points of all scanlines positioned at and below the first pixel horizon in a first sub-group of the one or more sub-groups.

In step 1530 in FIG. 15, the pre-compression processor selects a second scanline of the one or more scanlines as a second pixel horizon. Scanlines located at and above the second pixel horizon have data point densities that are greater than or equal to the threshold data point density. Scanlines located above the first pixel horizon and below the second pixel horizon have data point densities that are less than the threshold data point density. Therefore, there is sparse amount of points regions between the first pixel horizon and the second pixel horizon. In contrast, regions with dense clusters of points are below the first pixel horizon or above the second pixel horizon.

In step 1540 in FIG. 15, the pre-compression processor includes data points of all scanlines positioned at and above the second pixel horizon in a second sub-group of the one or more sub-groups. As a result, the pre-compression processor identifies regions with dense clusters of points for the compression, i.e., data points at and below the first pixel horizon and at and above the second pixel horizon, thereby achieving a more efficient data compression.

In some embodiments, the header encoder further encodes a frame header. The frame header indicates a quantity of data points of the identified one or more sub-groups of the uncompressed point cloud data. The frame header also indicates a quantity of data points other than the data points included in the identified one or more sub-groups of the uncompressed point cloud data. The frame header also indicates one or more coordinates representing one or more scanlines selected as pixel horizons. For each pixel horizon, scanlines located on one side of the pixel horizon have data point densities that are less than a threshold data point density. Scanlines located at and on the other side of the pixel horizon have data point densities that are greater than or equal to the threshold data point density.

FIG. 16 a flowchart illustrating an example method 1230 for encoding sub-groups of uncompressed point cloud data according to some embodiments. The step 1230 in FIG. 16 is the same step 1230 in FIG. 12. The data encoder encodes the one or more sub-groups of the uncompressed point cloud data using differential coordinates to obtain first encoded point cloud data.

In step 1610 in FIG. 16, the data encoder encodes data points of each scanline in the sub-group using the differential coordinates. The differential coordinates represent differences between absolutes coordinates of two neighboring data points of the uncompressed point cloud data. A quantity of bits required for encoding using the differential coordinates is less than a number of bits required for encoding using absolute coordinates.

In step 1612 in FIG. 16, the data encoder encodes a first data point corresponding to the beginning of the scanline using absolute coordinates. The absolute coordinates are 3-dimensional coordinates of the data points.

In step 1614 in FIG. 16, the data encoder encodes subsequent data points of the scanline using differences of absolute coordinates between neighboring data points.

In step 1620 in FIG. 16, the frame header encodes a scanline header. The scanline header indicates a quantity of data points of the scanline. The scanline header also indicates that a scanline is used for the encoding.

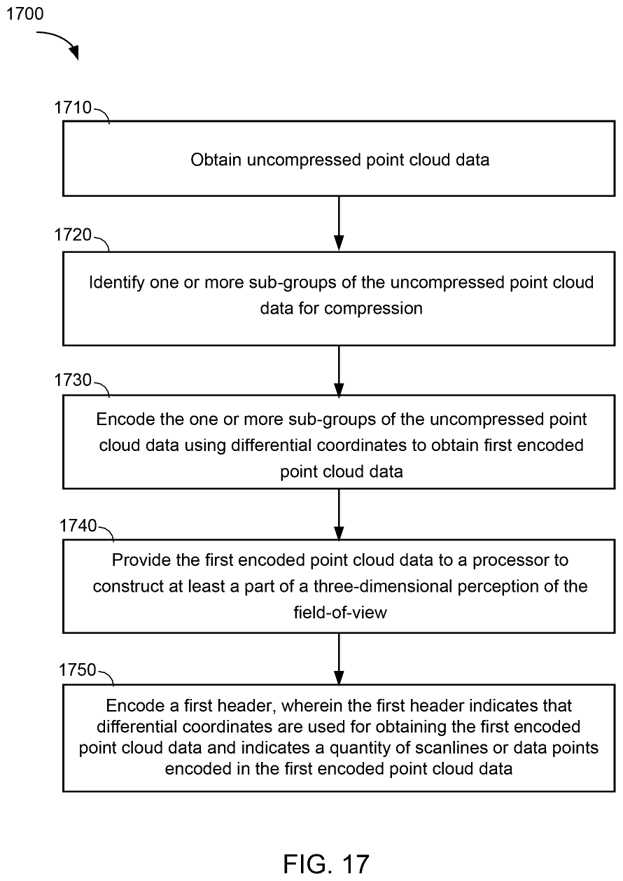

FIG. 17 shows a flowchart illustrating another example method 1700 for compressing point cloud data obtained by a LiDAR system according to some embodiments. The steps 1710-1740 are identical to steps 1210-1240 in FIG. 12 and thus not repeatedly described herein.

In step 1750 in FIG. 17, the header encoder further encodes a first header. The first header indicates that differential coordinates are used for obtaining the first encoded point cloud data. The first header also indicates a quantity of scanlines or data points encoded in the first encoded point cloud data.

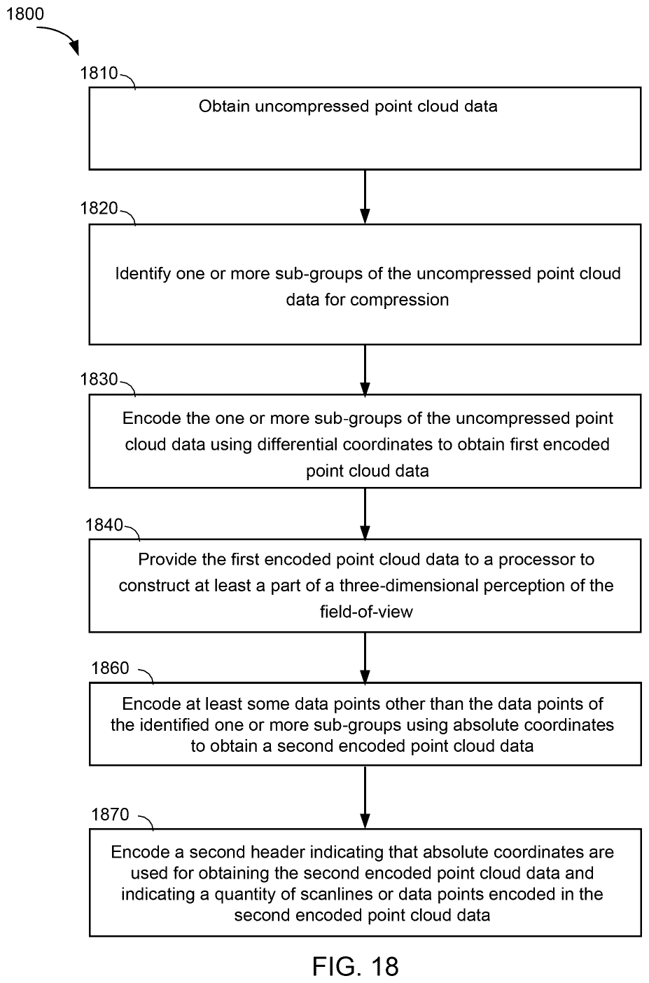

FIG. 18 shows a flowchart illustrating another example method 1800 for compressing point cloud data obtained by a LiDAR system according to some embodiments. The steps 1810-1840 are identical to steps 1210-1240 in FIG. 12 and thus not repeatedly herein.

In step 1860 in FIG. 18, the data encoder further encodes at least some data points using absolute coordinates to obtain a second encoded point cloud data. The encoded data points are data points other than the data points of the identified one or more sub-groups.

In step 1870 in FIG. 18, the header encoder further encodes a second header. The second header indicates that absolute coordinates are used for obtaining the second encoded point cloud data. The second header also indicates a quantity of scanlines or data points encoded in the second encoded point cloud data.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A computer-implemented method for compressing point cloud data obtained by a light ranging and detection (LiDAR) system, the method comprising:
obtaining uncompressed point cloud data, wherein each of the uncompressed point cloud data is represented by 3-dimensional coordinates identifying positions within a field-of-view of the LiDAR system, at least one of the 3-dimensional coordinates being derived from a time-of-flight measured by transmitting a light beam to the field-of-view and receiving return light formed based on the transmitted light beam;
identifying one or more sub-groups of the uncompressed point cloud data for compression, wherein data points of the one or more sub-groups representing positions of one or more regions within the field-of-view;
encoding the one or more sub-groups of the uncompressed point cloud data using differential coordinates to obtain first encoded point cloud data; and
providing the first encoded point cloud data to a processor to construct at least a part of a three-dimensional perception of the field-of-view.

2. The method of claim 1, wherein the uncompressed point cloud data comprise one or more frames of data points.

3. The method of claim 1, wherein the 3-dimensional coordinates comprise Cartesian coordinates in X, Y, and Z directions.

4. The method of claim 1, wherein the 3-dimensional coordinates comprise spherical coordinates represented by horizontal angular coordinates, vertical angular coordinates, and distance coordinates.

5. The method of claim 1, wherein the 3-dimensional coordinates comprise polar coordinates, or cylindrical coordinates.

6. The method of claim 1, wherein identifying the one or more sub-groups of the uncompressed point cloud data for compression comprises:
for each frame of the uncompressed point cloud data, identifying the one or more sub-groups for compression based on data point densities of a plurality of scanlines of the frame.

7. The method of claim 6, wherein identifying the one or more sub-groups for compression based on the data point densities of the plurality of scanlines of the frame comprises:
for each of the plurality of scanlines,
computing the data point density of the scanline, and
determining whether the data point density of the scanline is greater than or equal to a threshold data point density; and
in accordance with a determination that the data point densities of one or more scanlines are greater than or equal to the threshold data point density, including data points of at least the one or more scanlines into the one or more sub-groups for compression.

8. The method of claim 7, wherein determining whether the data point density of the scanline is greater than or equal to the threshold data point density comprises at least one of:
determining whether an average distance between neighboring data points of the scanline is less than a threshold data point distance, or
determining whether a quantity of the data points of the scanline is greater than or equal to a threshold data point quantity.

9. The method of claim 7, wherein including data points of at least the one or more scanlines into the one or more sub-groups for compression comprises:
selecting a first scanline of the one or more scanlines as a first pixel horizon, scanlines located above the first pixel horizon having data point densities that are less than the threshold data point density and scanlines located at and below the first pixel horizon having data point densities that are greater than or equal to the threshold data point density; and
including data points of all scanlines positioned at and below the first pixel horizon in a first sub-group of the one or more sub-groups.

10. The method of claim 9, further comprises:
selecting a second scanline of the one or more scanlines as a second pixel horizon, wherein:
scanlines located at and above the second pixel horizon have data point densities that are greater than or equal to the threshold data point density, and
scanlines located above the first pixel horizon and below the second pixel horizon have data point densities that are less than the threshold data point density,
including data points of all scanlines positioned at and above the second pixel horizon in a second sub-group of the one or more sub-groups.

11. The method of claim 7, wherein the plurality of scanlines comprises all scanlines in the frame.

12. The method of claim 1, further comprising encoding a frame header, the frame header indicating:
a quantity of data points of the identified one or more sub-groups of the uncompressed point cloud data;
a quantity of data points other than the data points included in the identified one or more sub-groups of the uncompressed point cloud data; and
one or more coordinates representing one or more scanlines selected as pixel horizons,
wherein for each pixel horizon, scanlines located on one side of the pixel horizon have data point densities that are less than a threshold data point density and scanlines located at and on the other side of the pixel horizon have data point densities that are greater than or equal to the threshold data point density.

13. The method of claim 1, further comprising:
encoding a first header, wherein the first header indicates that differential coordinates are used for obtaining the first encoded point cloud data and indicates a quantity of scanlines or data points encoded in the first encoded point cloud data.

14. The method of claim 1, wherein encoding the one or more sub-groups of the uncompressed point cloud data using differential coordinates to obtain first encoded point cloud data comprises, for each sub-group of the one or more sub-groups:
encoding data points of each scanline in the sub-group using the differential coordinates; and
for each scanline, encoding a scanline header indicating a quantity of data points of the scanline and indicating that a scanline is used for the encoding.

15. The method of claim 14, wherein encoding data points of each scanline in the sub-group using the differential coordinates comprises:
encoding a first data point corresponding to the beginning of the scanline using absolute coordinates; and
encoding subsequent data points of the scanline using differences of absolute coordinates between neighboring data points.

16. The method of claim 1, further comprising:
encoding at least some data points other than the data points of the identified one or more sub-groups using absolute coordinates to obtain a second encoded point cloud data; and
encoding a second header indicating that absolute coordinates are used for obtaining the second encoded point cloud data and indicating a quantity of scanlines or data points encoded in the second encoded point cloud data.

17. The method of claim 1, further comprising, for at least one sub-group of the one or more sub-groups:
encoding coordinates of a beginning position and an end position of the sub-group.

18. The method of claim 1, wherein a quantity of bits required for encoding using the differential coordinates is less than a number of bits required for encoding using the absolute coordinates.

19. The method of claim 1, wherein the differential coordinates represent differences between absolutes coordinates of two neighboring data points of the uncompressed point cloud data.

20. A light ranging and detection (LiDAR) system used for compressing point cloud data, comprising:
a transmitter configured to transmit one or more light beams;
a scanner configured to scan the one or more light beams to a field-of-view;
a receiver configured to receive return light formed based on the scanned one or more light beams; and
a controller comprising one or more processors and memory, wherein the controller is configured to perform a method for compressing point cloud data obtained by the LiDAR system, the method comprising:
obtaining uncompressed point cloud data, wherein each of the uncompressed point cloud data is represented by 3-dimensional coordinates identifying positions within a field-of-view of the LiDAR system, at least one of the 3-dimensional coordinates being derived from a time-of-flight measured by transmitting a light beam to the field-of-view and receiving return light formed based on the transmitted light beam;
identifying one or more sub-groups of the uncompressed point cloud data for compression, wherein data points of the one or more sub-groups representing positions of one or more regions within the field-of-view;
encoding the one or more sub-groups of the uncompressed point cloud data using differential coordinates to obtain first encoded point cloud data; and
providing the first encoded point cloud data to a processor to construct at least a part of a three-dimensional perception of the field-of-view.

21. A vehicle comprising a light ranging and detection (LiDAR) system, wherein the LiDAR system is configured to perform a method for compressing point cloud data obtained by the LiDAR system, the method comprising:
obtaining uncompressed point cloud data, wherein each of the uncompressed point cloud data is represented by 3-dimensional coordinates identifying positions within a field-of-view of the LiDAR system, at least one of the 3-dimensional coordinates being derived from a time-of-flight measured by transmitting a light beam to the field-of-view and receiving return light formed based on the transmitted light beam;
identifying one or more sub-groups of the uncompressed point cloud data for compression, wherein data points of the one or more sub-groups representing positions of one or more regions within the field-of-view;
encoding the one or more sub-groups of the uncompressed point cloud data using differential coordinates to obtain first encoded point cloud data; and
providing the first encoded point cloud data to a processor to construct at least a part of a three-dimensional perception of the field-of-view.

22. A non-transitory computer readable medium comprising a memory storing one or more instructions which, when executed by one or more processors of at least one computing device, cause the at least one computing device to perform a method for compressing point cloud data obtained by a light ranging and detection (LiDAR) system, the method comprising:
obtaining uncompressed point cloud data, wherein each of the uncompressed point cloud data is represented by 3-dimensional coordinates identifying positions within a field-of-view of the LiDAR system, at least one of the 3-dimensional coordinates being derived from a time-of-flight measured by transmitting a light beam to the field-of-view and receiving return light formed based on the transmitted light beam;
identifying one or more sub-groups of the uncompressed point cloud data for compression, wherein data points of the one or more sub-groups representing positions of one or more regions within the field-of-view;
encoding the one or more sub-groups of the uncompressed point cloud data using differential coordinates to obtain first encoded point cloud data; and
providing the first encoded point cloud data to a processor to construct at least a part of a three-dimensional perception of the field-of-view.
